(19) United States
(12) Patent Application Publication
(10) Pub. No.: US 2008/0263553 A1
(43) Pub. Date: Oct. 23, 2008

(54) Dynamic Service Level Manager for Image Pools

(75) Inventors: Einar Lueck, Weil im Schoenbuch (DE); Gerd Breiter, Wildberg (DE); Michael Behrendt, Randersacker (DE)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 12/104,009

(22) Filed: Apr. 16, 2008

(30) Foreign Application Priority Data
Apr. 19, 2007 (DE) 07106495.0
Apr. 19, 2007 (EP) 07106495.0

(51) Int. Cl. G06F 9/46

(52) U.S. Cl. 718/102

(57) ABSTRACT

An embodiment of the present invention relates to the field of computer technology, in particular it relates to a method for provisioning images for virtual machines, wherein for a predefined application type a pool of at least one image of a virtual machine performing said application is loaded in the main memory of the computer.

### CROSS-REFERENCE TO RELATED APPLICATION

This present application claims priority of a German Patent Application Number 07106495.0 filed on Apr. 19, 2007.

### BACKGROUND OF THE INVENTION

1. Field of the Invention

An embodiment of the present invention relates to the field of computer technology, particularly to the area of virtualization, wherein computer resources are emulated and simulated in order to offer the possibility to replace the computing resources such as storage, applications, computational resources of a workstation by a resource of a mostly central computer network connected with the owner of the workstation, in order to offer more efficient computing facilities. In particular it relates to a method for provisioning images for virtual machines, wherein for a predefined application type a pool of at least one image of a virtual machine performing said application is loaded in the main memory of the computer.

2. Description and Disadvantages of Prior Art

In the prior art, images have to be created manually or by a provisioning system. More specific understanding with respect to the prior art will be described herein below with respect to FIG. 1.

With respect to prior art FIG. 1, depicting the architectural system environment of a Provisioning System 18, virtual machines 14A, 14B base on so called Hypervisor Systems 12, (e.g. VMWare ESX Server) that assign physical resources of a machine to (multiple) virtual ones. The key behind these provisioning systems 18 that base on virtualization technology is that Virtual Machines 14 are completely representable as binary images 22 A, 22B on (non-volatile) storage 20. Their complete state is captured in such an image 22.

If one creates a new virtual machine 14, installs several applications 16 on it and configures them, one may represent this complete machine and it's complete state (e.g. which applications are currently running) as a (binary) image 22. Consequently, by copying an image 22 of a virtual machine one creates a new virtual machine. A Hypervisor 12 may then be triggered to start this new virtual machine—this is done by triggering the Hypervisor with a “pointer” to the new image.

Provisioning Systems based on virtual machine images exploit these characteristics. Instead of assigning one dedicated physical machine 10 and installing the requested operating system and the requested applications on it to a corresponding user request, the provisioning system 18 creates a Virtual Machine. The provisioning system 18 offers a certain set of application/operating system combinations to its users. For each of these combinations it has a (binary) master image 26A, 26B. Every time a user requests a machine with an application/operating system combination, the provisioning system looks up the corresponding master image, creates a copy of that image—the copy then automatically corresponds to the requested machine—and then starts the machine by triggering the hypervisor 12 of the physical machine 10 on which the virtual machine should be located.

Considering the provisioning process as a whole, the copy operation is the most time consuming process. It depends on the size of the corresponding image. Especially, when the machine becomes very complex (complex applications like application server or multiple applications on one machine) the images get very large. The time consumption of the prior art copy operation is therefore quite disadvantageous.

### SUMMARY AND ADVANTAGES OF THE INVENTION

The invention is based on the idea of removing the copy operation from the provisioning path for a new virtual machine.

According to its broadest aspect An embodiment of the present invention discloses a method and respective system for provisioning images for virtual machines, wherein for a predefined application type—which may be client specific, application specific, availability specific—a pool of at least one image of a virtual machine performing said application—preferably some plurality of them—is loaded in the main memory of the computer,

which method is characterised by the steps of:
a) calculating for a predetermined future time—e.g. 1.5 hours, 24 hours, some days, freely scalable—a required number of images of said virtual machines which are expected to be requested by a client in this time range, wherein the calculation is based on at least one of the following items:
1) statistics from historic request workload to said virtual machines,
2) the availability of overall memory space remaining unallocated yet for a storage,
wherein this is done preferably by additionally evaluating predetermined quality of service criteria associated with the client,
b) in response to a request for a new virtual machine image, delivering a link to a hypervisor function processing the request, wherein the link points to a pre-prepared image copy of the respective virtual machine.

Herein, it is proposed that an actor program is introduced that is responsible for automatically creating images for new Virtual Machines autonomously based on predetermined Service Level Agreements.

The advantage results that at the point in time when a request actually comes in, an image copy already exists and can immediately be provided to the dispatcher of the image without that it would be necessary to generate a copy at the time, when the request is received. Thus, the expected response to the request can be provided faster.

With respect to the derivation and utilization of statistics it is proposed that the Service Level Manager collects and maintains at least the following statistics:
Overall number of requests for a Virtual Machine type;
Average number of requests for Virtual Machines of a certain type;
Requests over time on based on the type of a Virtual Machine.

The innovative method further includes the preferred aspects of pre-allocation according to an average number of requests, anticipating load peaks in time, and pre-populating new storage for the purpose of anticipating requests and more efficiently satisfying SLAs.

### BRIEF DESCRIPTION OF THE DRAWINGS

The present invention is illustrated by way of example and is not limited by the shape of the figures of the drawings in which:

FIG. 1 illustrates the most basic structural components of a prior art hardware and software environment used for a prior art method,

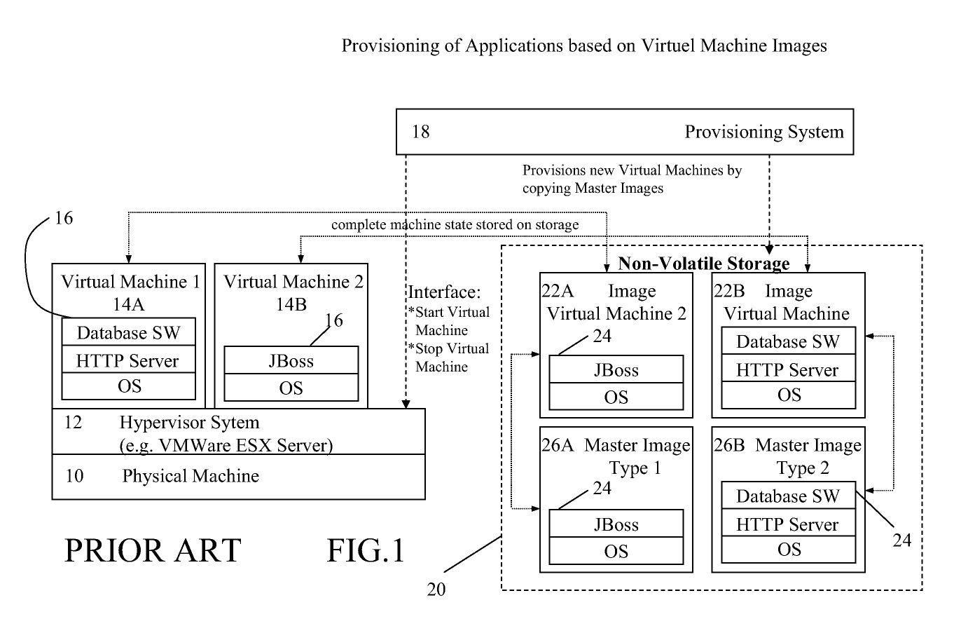

FIG. 2 illustrates the most basic structural components of a innovative hardware and software environment used for a preferred embodiment of the innovative method,

FIG. 3 illustrates the control flow of the interactive steps of a preferred embodiment of the innovative method performed during Pre-Allocation according to the average number of requests;

FIG. 4 illustrates the control flow of the interactive steps of a preferred embodiment of the innovative method performed during Anticipation of Load Peaks in time;

FIG. 5 illustrates the control flow of the interactive steps of a preferred embodiment of the innovative method performed during pre-population of new storage;

### DETAILED DESCRIPTION OF THE PREFERRED EMBODIMENT

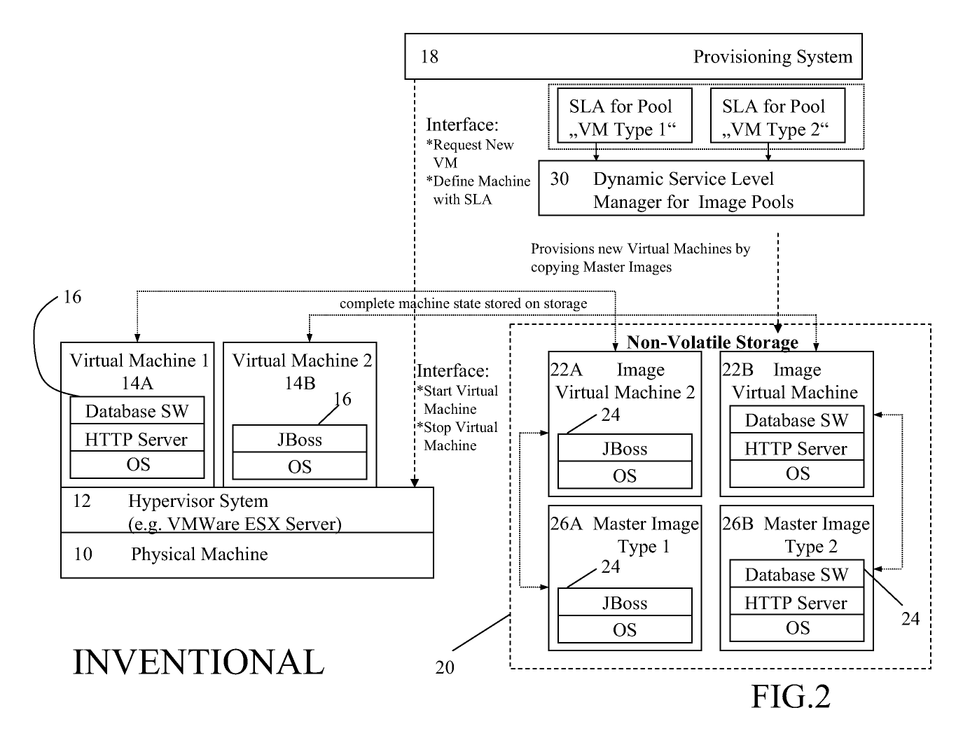

FIG. 2 illustrates the system architecture of an innovative embodiment.

Herein, all Virtual Machine images are grouped into types. So for each Virtual Machine image 22A, 22B there is a kind of master copy 26A, 26B, respectively, that determines its type. The Hypervisor 12 or a management system always requests new Virtual Machine images 2 from a control program called “Service Level Manager” 30 provided by an embodiment of the invention on a type basis such as a request for a Virtual Machine of a Type “B”.

The Service Level Manager 30 is allowed according to an embodiment of the invention to create image copies 22A, 22B independently from requests. If it already has created an image copy 22 when one is requested by a Hypervisor 12, the Hypervisor may immediately start the machine and use it. By that the time-consuming copy operation for the huge image is removed from the “provisioning path”. Especially for self-service GUIs this time savings are very important.

An embodiment of the present invention proposes that the behaviour of the Service Level Manager 30 is controlled by so called “Service Level Agreements”, abbreviated herein as SLA, 32, 34 between the client and the provisioner, and by an overall limit of storage that may be occupied by images. For each type of Virtual Machine, there is provided a Service Level Agreement. The Service Level Agreements indirectly controls for which type of Virtual Machines how many copies need to be reserved for immediate availability for new Virtual Machines of the particular type.

Furthermore, those agreements need to contain enough information to allow the Service Level Manager 30 to derive which type of Virtual Machine may be more important in a bottleneck situation e.g., when getting out of storage. There may be multiple types of Service Level Agreements 32, 34.

The following code snippet gives an example of how a Service Level Agreement 32, 34 in XML Style may look like:

<imageSLA>
<imageType>myMasterImage</imageType>
<masterImage>/images/myMasterImage</masterImage>
<averageResponseTime>0.150</averageResponseTime>
<priority>3</priority>
</imageSLA>

This SLA for the image type “myMasterImage” refers primarily to the master image that needs to be copied for new requests for Virtual Machines of the type “myMasterImage”. Further in this code snippet, an average response time for Virtual Machine requests is specified. Finally, a priority is given. This priority allows the Service Level Manager to decide which type of image to favour, if it runs out of storage space. As an example, one may envision that the Service Level Manager 30 shrinks the pool of images for “myMasterImage”s, if there is an SLA for “myRealImportantIMage” type of Virtual Machines that needs more machines and has a higher priority.

Next the derivation and utilization of statistics used for determining the probably requested number of copies will be described in more detail. Herefore, it is proposed that the Service Level Manager 30 collects and maintains at least the following statistics:
Overall number of requests for a Virtual Machine type
Average number of requests for Virtual Machines of a certain type
Requests over time on type of Virtual Machine basis

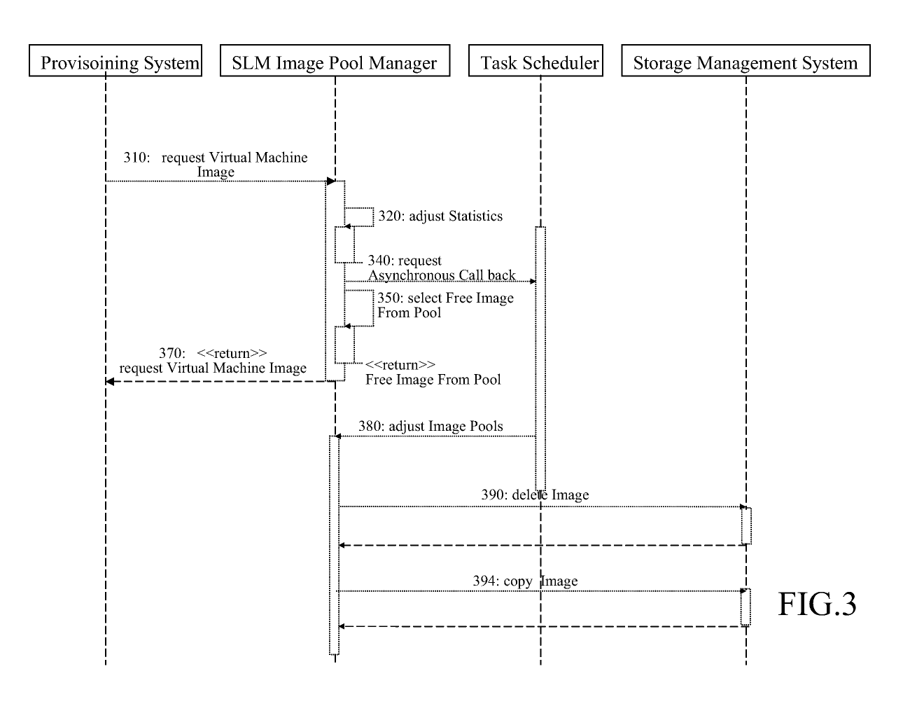

Due to the fact that all Virtual Machine requests go through the Service Level Manager 30 this control logic is capable of collecting the mentioned statistics. There are at least the following methods introduced and illustrated with FIGS. 3, 4 and 5 for exploiting these statistics which are described in more detail below.

FIG. 3 illustrates the interaction control flow for the pre-allocation according to an average number of requests:

In step 310 the provisioning system requests an image of a virtual machine of a given type. In this request, it passes a parameter playing the role of an identifier which identifies the type of virtual machine image that the provisioning system wants to have.

The Image Pool Manager then adjusts its internal statistics in step 320. For each type of virtual machine image it maintains a number which corresponds to the average number of requests for the image in a defined time period (e.g. 1 month). The number is adjusted accordingly.

After that, the Image Pool Manager requests at the Task Scheduler Component, which is just responsible for triggering arbitrary components asynchronously, that it gets called back, see step 340.

Finally, the image pool manager selects an already existing unused image from the corresponding image pool in step 350. For this, no image needs to be copied as long as the image pool is not empty. The latter case is not depicted in FIG. 3. The selected image is marked as “used” in the virtual machine image pool of the requested type. After the address of the image in the file system is returned to the provisioning system see step 370, the Image Pool Manager is asynchronously called in step 380 by the Task Scheduler as requested in step 340.

This asynchronous notification of step 380 triggers that the Image Pool Manager checks whether the number of available images in each pool relatively corresponds to the weighted average number of requests in the well defined time period.

The average is always maintained in Step 320. The weight is derived from the service level agreements. As an example one could multiply it with the sum of all priorities given in SLAs for each image type and with the inverted average response time. If a mismatch is detected and there is no free storage space left, the Image Pool Manager deletes images—see step 390—and copies images—step 394—accordingly through requests at the corresponding storage subsystem.

From the average number of requests for a particular type of Virtual Machine, the Service Level Manager may derive how much Virtual Machines copies of each type should always be there for each type. If the Service Level Manager runs out of storage space he may use a ranking over the average number of requests per Virtual Machine type in order to select the least popular for a reduction in unused copies.

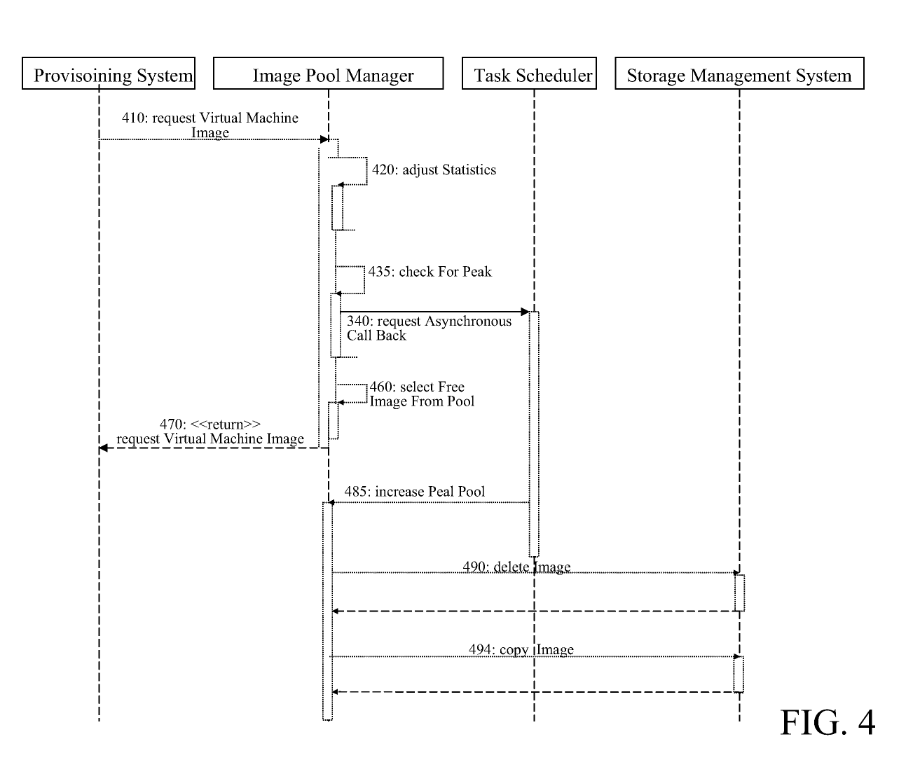

With respect to FIG. 4 and the innovative anticipation of load peaks in time, even if the Service Level Manager adheres to averages, there may be certain request peaks for each type of Virtual Machine. As an example one may envision a situation in which the average number of unused copies for Virtual Machine Type is three in a timeframe of two weeks, but six are always requested at once and then there are no requests for two weeks. This knowledge about how requests are distributed over time may be exploited by the Service Level Manager to anticipate these situations and always provide six copies at certain points in time.

FIG. 4 illustrates the Interaction control flow diagram for the innovative anticipation of load peaks in time.

The implementation of the anticipation of load peaks in time is an extension of the implementation proposed in the previous section of FIG. 3 and is illustrated in FIG. 4. Corresponding references are yielded just by incrementing by 100. Basically, only differences to the FIG. 3 control flow are described.

In step 420 not only the number of requests per virtual image type in a well defined time period is maintained, the number of requests are also aggregated in very short time periods and a function/curve is derived (e.g. average number of requests on Tuesday or average number of requests before 12 pm).

After that, the Image Pool Manager checks in a step 335, whether the current request curve for the type of virtual machine corresponds to the historic one (e.g. by measuring the difference between the historic curve and the curve for this week) and if the historic one indicates a load peak, see step 335. This can be accomplished for example through a curve discussion. If a peak is determined, then the anticipated number of requests will be derived (extreme value). This value is given as a parameter to the request for an asynchronous callback at the Task Scheduler, see step 340.

After that the current request for a new image is satisfied as described in the previous section see step 460. The Task Scheduler then asynchronously calls the Image Pool Manager—see step 485. The latter ensures that for the particular image type the number of anticipated requests may be satisfied. This is achieved through deleting less important images (e.g. according to the lowest weighted average described in the previous section) in step 490 and copying of the corresponding images in Step 492 through calls to the Storage Subsystem.

With respect to the innovative pre-population of new storage, it is very likely that new storage needs to be added to a Service Level Manager occasionally. This may be assumed to be the case when there are too often bottleneck situations and the probability that an image needs to be copied when a request arrives increases significantly. The most important point in a bottleneck situation is to reduce the probability of a miss—an image needs to be copied when a request arrives—as fast as possible. Due to the fact that the Service Level Manager has at least the statistics described above this control logic may use these statistics immediately when storage space is added to him. It thus pre-populates the new storage space according to these statistics.

### EXAMPLE

If the storage space for the Service Level Manager is increased by a certain amount, the Service Level Manager may assign to each pool the size based on the average request rate and may pre-populate the assigned space with copies.

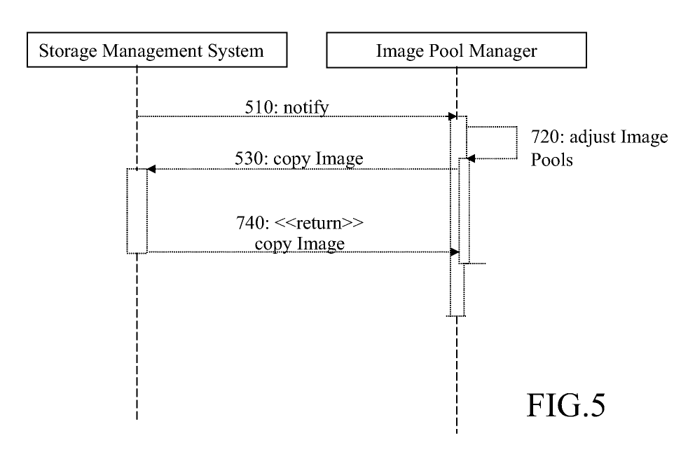

FIG. 5 illustrates the control flow for the innovative way of prepopulating new storage.

The innovative implementation of the Pre-Population logic utilizes the implementation of pre-allocation based on a weighted average number of requests.

The major addition is that the Storage Management System notifies the Image Pool Manager when new storage for the Image Pool Management is added (e.g. a new hard disc)—see step 510. The Image Pool Manager then immediately populates the new storage space based on the statistics as described further above. The population is achieved through copying, see step 530.

An embodiment of the invention can take the form of an entirely hardware embodiment, an entirely software embodiment or an embodiment containing both hardware and software elements. In a preferred embodiment, an embodiment of the invention is implemented in software, which includes but is not limited to firmware, resident software, microcode, etc.

Furthermore, an embodiment of the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

1. A method for provisioning images for virtual machines, wherein for a predefined application type a pool of at least one image of a virtual machine performing said application is loaded in the main memory of the computer,
comprising the steps of:
a) calculating for a predetermined future time a required number of said virtual machines images of a given type (A,B) which are expected to be requested by a client, wherein the calculation is based on at least one of the following items:
1) statistics from historic request workload to said virtual machines,
2) the availability of overall memory space remaining unallocated yet for a storage,
b) in response to a request for a new virtual machine image, delivering a link to a hypervisor function processing the request, wherein the link points to a pre-prepared image copy of the respective virtual machine.

2. The method according to claim 1, further comprising the step of generating image copies in advance to and asynchronically to the incoming requests.

3. The method according to claim 1, wherein said calculation step is based on at least one of:
a) a pre-allocation according to an average number of incoming requests,
b) an anticipation of load peaks in time, or
c) a pre-population of new storage.

4. An electronic data processing system for provisioning images for virtual machines, wherein for a predefined application type a pool of at least one image of a virtual machine performing said application is loaded in the main memory of the computer, comprising:
a) means for calculating for a predetermined future time a required number of said virtual machines images of a given type (A,B) which are expected to be requested by a client, wherein the calculation is based on at least one of the following items:
1) statistics from historic request workload to said virtual machines,
2) the availability of overall memory space remaining unallocated yet for a storage,
b) means for delivering a link to a hypervisor function processing the request, wherein the link points to a pre-prepared image copy of the respective virtual machine.

5. A computer program product for provisioning images for virtual machines, wherein for a predefined application type a pool of at least one image of a virtual machine performing said application is loaded in the main memory of the computer, comprising a computer useable medium including a computer readable program, wherein the computer readable program includes a functional component that when executed on a computer causes the computer to perform the steps of:
a) calculating for a predetermined future time a required number of said virtual machines images of a given type (A,B) which are expected to be requested by a client, wherein the calculation is based on at least one of the following items:
1) statistics from historic request workload to said virtual machines,
2) the availability of overall memory space remaining unallocated yet for a storage,
b) in response to a request for a new virtual machine image, delivering a link to a hypervisor function processing the request, wherein the link points to a pre-prepared image copy of the respective virtual machine.
